(19) United States
(12) Patent Application Publication
(10) Pub. No.: US 2011/0318121 A1
(43) Pub. Date: Dec. 29, 2011

(54) CUTTING TIP COMPRISING A GROOVED SHANK, AND CUTTING TOOL COMPRISING SUCH A CUTTING TIP

(75) Inventor: Jan Eriksson, Fagersta (SE)

(73) Assignee: SECO TOOLS AB, Fagersta (SE)

(21) Appl. No.: 13/255,430

(22) PCT Filed: Mar. 26, 2010
(86) PCT No.: PCT/SE2010/050334

§ 371 Date: Sep. 14, 2011

(30) Foreign Application Priority Data
Mar. 27, 2009 (SE) 095194-1

(51) Int. Cl. B23C 5/22; B23B 27/16

(52) U.S. Cl. 407/102; 407/120

(57) ABSTRACT

A cutting tip for a cutting tool includes a tool portion including a cutting edge, and a shank portion connected at a first end to the tool portion. The tip comprises at least three grooves in the shank portion, at least a portion of each groove extending circumferentially around at least part of the shank portion, a centering structure for centering the shank portion relative to an opening in a toolholder, and an axial stop for limiting axial movement of the shank portion into the opening in the toolholder, the axial stop and the centering structure being different structures.

### BACKGROUND AND SUMMARY

The present invention relates generally to a cutting tip comprising a grooved shank.

Certain cutting tools involve attachment of a cutting tip to a toolholder. Often, a shank of the cutting tip is provided with an external thread and the toolholder is provided with an internal thread. Forming the internal thread in the toolholder can be difficult, and damage to the internal thread can prevent use of the toolholder with undamaged cutting tips.

It is desirable to provide a cutting tool comprising a cutting tip and a toolholder that can be quickly and reliably secured together. It is also desirable to provide a cutting tool comprising a cutting tip and a toolholder that does not require an internal thread on the toolholder to secure a cutting tip having an externally grooved or threaded shank.

In accordance with an aspect of the present invention, a cutting tip for a cutting tool comprises a tool portion comprising a cutting edge, and a shank portion connected at a first end to the tool portion. The tip comprises at least three grooves, at least a portion of each groove extending circumferentially around at least part of the shank portion, a centering structure for centering the shank portion relative to an opening in a toolholder, and an axial stop for limiting axial movement of the shank portion into the opening in the toolholder, the axial stop and the centering structure being different structures.

In accordance with another aspect of the present invention, a cutting tool comprises a cutting tip comprising a tool portion and a shank portion connected to the tool portion, the shank portion comprising at least one groove, at least a portion of the groove extending circumferentially around at least part of the shank portion, and at least a bottom of the groove being defined by a radiused surface, and a toolholder comprising a wall defining an axial opening for receiving the shank portion of the cutting tip, the wall comprising at least one through-hole, and an at least partially spherical member, the at least partially spherical member being received in the through hole such that a spherical portion of the at least partially spherical member extends through the through hole into the axial opening. The cutting tip is secured to the toolholder when the shank portion of the cutting tip is received in the axial opening and at least part of the spherical portion of the at least partially spherical member is received in the groove in the cutting tip.

### BRIEF DESCRIPTION OF THE DRAWINGS

The features and advantages of the present invention are well understood by reading the following detailed description in conjunction with the drawings in which like numerals indicate similar elements and in which:

FIG. 1A is an exploded, side, partially cross-sectional view of a cutting tool according to an aspect of the present invention;

FIG. 1B is a side, partially cross-sectional view of the cutting tool of FIG. 1A as assembled;

FIG. 1C is a top view of the toolholder of the cutting tool of FIG. 1A;

FIG. 1D is a side, partially cross-sectional view of a portion of the cutting tool of FIG. 1A as assembled;

FIGS. 2A and 2B are a side, partially cross-sectional view and a top view of a toolholder of a cutting tool according to another aspect of the present invention;

FIGS. 2C and 2D are a bottom view and a side view of a cutting tip of a cutting tool according to another aspect of the present invention;

FIG. 3A is an exploded, side, partially cross-sectional view of a cutting tool according to another aspect of the present invention;

FIG. 3B is a side, partially cross-sectional view of the cutting tool of FIG. 3A as assembled;

FIG. 4A is an exploded, side, partially cross-sectional view of a cutting tool according to another aspect of the present invention;

FIG. 4B is a side, partially cross-sectional view of the cutting tool of FIG. 4A as assembled;

FIGS. 5A and 5B are a bottom view and a side view of a cutting tip of a cutting tool according to another aspect of the present invention;

FIG. 5C is a side, partially cross-sectional view of a toolholder of a cutting tool according to another aspect of the present invention, and FIG. 5D is a cross-sectional view of the toolholder of FIG. 5C taken at section 5D-5D;

FIG. 6 is a side, partially cross-sectional view of portion of a shank and a toolholder of a cutting tool according to another aspect of the present invention;

FIG. 7 is a side, partially cross-sectional view of portion of a shank and a toolholder of a cutting tool according to yet another aspect of the present invention.

### DETAILED DESCRIPTION

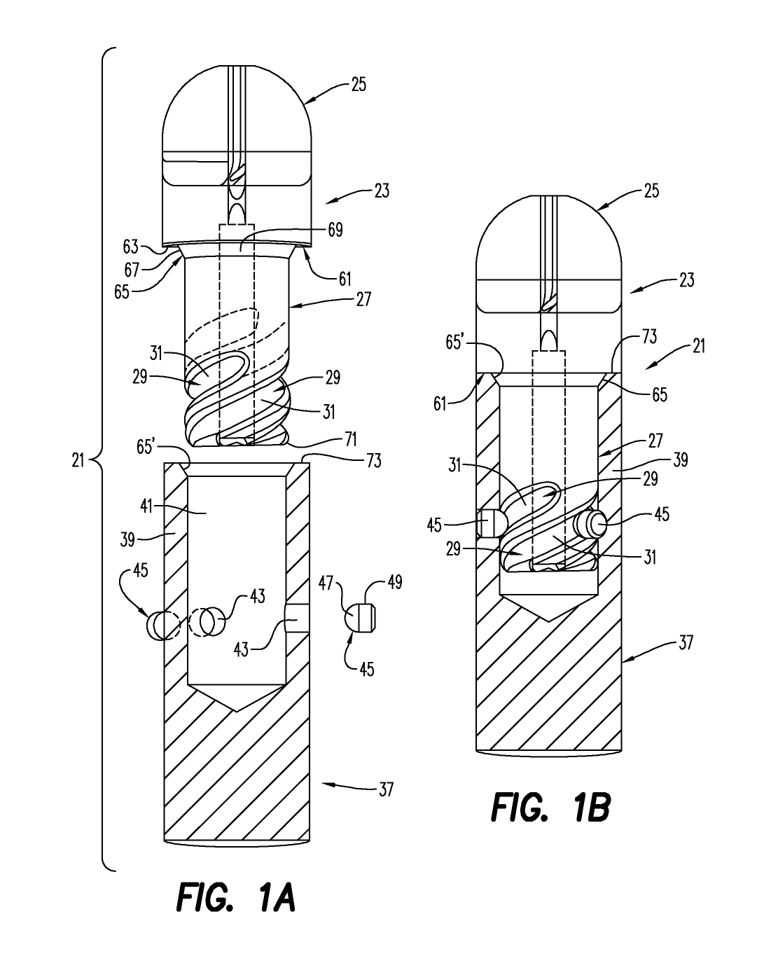

A cutting tool 21 according to an aspect of the present invention is shown in FIG. 1A-1D. The cutting tool 21 comprises a cutting tip 23 comprising a tool portion 25 and a shank portion 27 connected to the tool portion. The cutting tip 23 is typically formed of a cemented carbide material that has been pressed and sintered, however, the cutting tip can be formed of a wide variety of other materials. The tool portion 25 in the illustrated embodiments is a ball-nose endmill tool, however, it will be appreciated that the tool portion can comprise a variety of different tools.

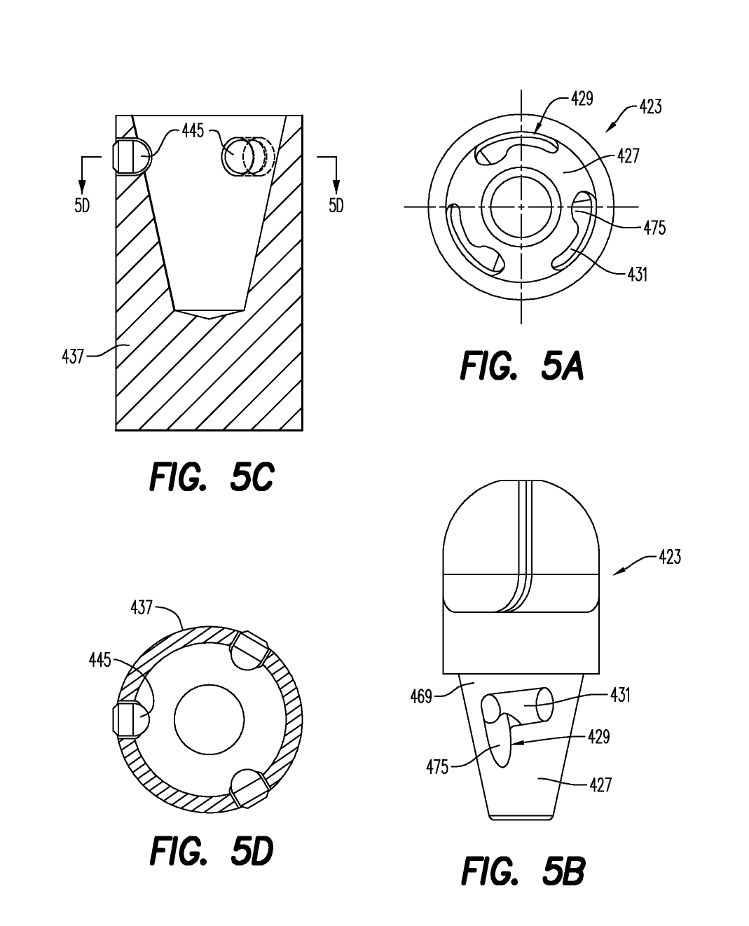

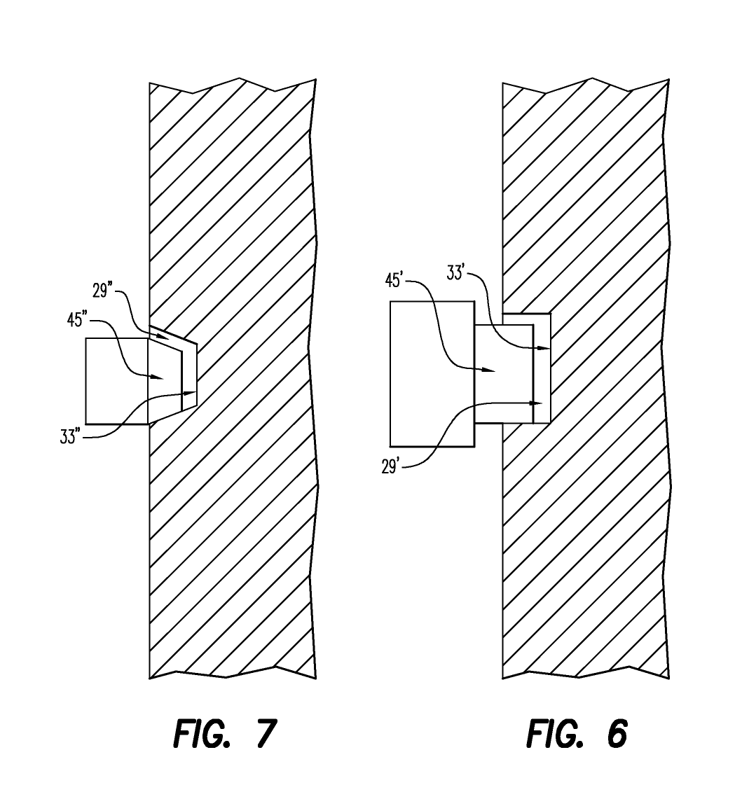

The shank portion 27 comprises at least one groove 29, and ordinarily comprises a plurality of grooves, such as two or three grooves. The grooves 29 ordinarily extend around the shank portion 27 at a pitch angle of between 1°-20°. At least a portion 31 of the groove 29 extends circumferentially around at least part of the shank portion 27. At least a bottom 33 (FIG. 1D) of the groove 29 is defined by a radiused surface 35. Forming the bottom 33 of the groove 29 with a radiused surface facilitates formation of the groove in a shank portion blank in a simple manner using, e.g., rotating tools or punches. As seen in FIGS. 6 and 7, the groove can have a shape other than a radiused surface. FIG. 6 shows the groove 29′ having a substantially square or rectangular surface 35′. FIG. 7 shows the groove 29″ having a substantially V-shaped surface 35″. The shapes of the grooves described here are intended to be illustrative, not limiting.

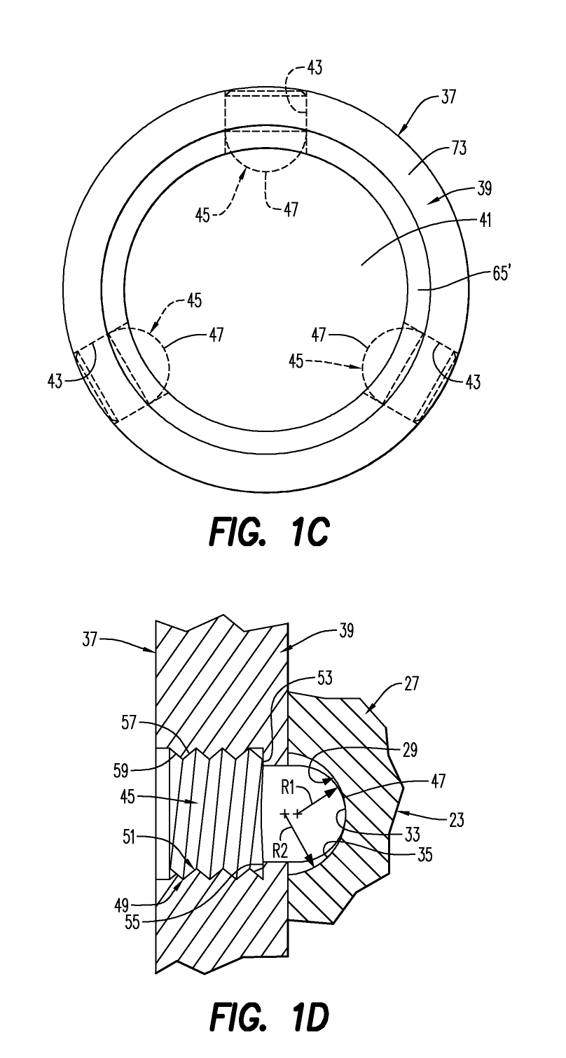

The cutting tool 21 comprises a toolholder 37 comprising a wall 39 defining an axial opening 41 for receiving the shank portion 27 of the cutting tip 23. The wall 39 comprises at least one through-hole 43, and ordinarily comprises a plurality of through holes at least equal in number to the number of grooves 29 in the shank portion 27. The toolholder 37 shown in FIGS. 1A-1D also comprises an at least partially spherical member 45. Toolholders shown in FIGS. 2A-5D also include at least partially spherical members. As seen in, e.g., FIG. 1C, the at least partially spherical member 45 (shown in phantom) is received in the through hole 43 (shown in phantom) such that a spherical portion 47 of the at least partially spherical member 45 extends through the through hole into the axial opening 41. The cutting tip 23 is secured to the toolholder 37 when the shank portion 27 of the cutting tip is received in the axial opening 41 and at least part of the spherical portion 47 of the at least partially spherical member 45 is received in the groove 29 in the cutting tip. As seen in FIG. 1D, to facilitate causing the spherical portion 47 of the at least partially spherical member 45 to seat at the radially innermost part of the groove 29, i.e., the bottom of the groove, the radius R1 of the spherical portion 47 is ordinarily less than a radius R2 of the radiused surface 35 of the groove.

The at least partially spherical member 45 can take a variety of forms. FIG. 1D shows an at least partially spherical member 45 according to an aspect of the present invention that comprises a cylindrical portion 49 having a shape complementary to a shape of a portion 51 of the through-hole 43. It is ordinarily desirable for the spherical portion 47 of the at least partially spherical member 45 to extend a precise distance into the axial opening 41 of the toolholder 37. As seen in FIG. 1D, one way of limiting the extent to which the spherical portion 47 is able to extend into the axial opening 41 of the toolholder 37 is by providing the at least partially spherical member 45 with a shoulder 53 (which may be provided as part of the cylindrical portion 49, if provided), and providing the through-hole 43 with a shoulder 55. The shoulder 53 of the at least partially spherical member 45 and the shoulder 55 of the through-hole 43 can be arranged so that an extent to which the spherical portion 47 is adapted to extend into the axial opening 41 is limited, i.e., when the shoulders abut, the spherical portion is unable to extend further into the axial opening.

It is ordinarily desirable to prevent the at least partially spherical member 45 from moving relative to or falling out of the through-hole 43. Therefore, in addition to having a shoulder 53, or instead of having a shoulder, the cylindrical portion 49 of the at least partially spherical member 45 can comprise an external thread 57, and the through-hole 43 can comprise an internal thread 59 for mating with the external thread on the at least partially spherical member. It is not necessary that a member be an at least partially spherical member as shown in FIGS. 1A-5B. FIGS. 6 and 7 show a substantially rectangular member 45′ and a substantially frustoconical member 45″ (appears V-shaped from the side) that would ordinarily be preferred for use with substantially rectangular or substantially V-shaped grooves 29′ and 29″, respectively.

The at least partially spherical member 45 can mate with the through-hole 43 via an interference fit, ordinarily as an alternative to, e.g., a threaded connection, although a threaded connection might be used in combination with an interference fit, as well. The interference fit may be created by appropriate sizing of the at least partially spherical member 45 and the through-hole 43. This can include selecting sizes so that at least partially spherical member 45, particularly the cylindrical portion 49, if provided on the at least partially spherical member, can be received in the through-hole 43 only by a “shrink fit” process whereby the wall 39 of the toolholder 23 is heated to enlarge the through hole 43, the at least partially spherical member (or its cylindrical portion 49) is positioned in the through-hole, and the through-hole clamps around the at least partially spherical member (or its cylindrical portion).

FIG. 1C shows three through holes 43 and (in phantom) three at least partially spherical members 45 equally spaced around a circumference of the axial opening 41 of the toolholder 37 and at the same axial positions on the toolholder. Fewer than three through holes may be provided. FIGS. 2A-2D, for example, show components of a cutting tool with two through holes 143 (FIGS. 2A-2B) equally spaced around the axial opening 141 of the toolholder 137 and two at least partially spherical members 145 for mating with two grooves 129 (FIGS. 2C-2D) on a shank portion 127 of a cutting tip 123. The through holes may be located at different axial positions, and may be positioned so that more than one at least partially spherical member is received in a groove. Positioning the through holes with equal spacing around the circumference of the axial opening of the toolholder and at the same axial position can facilitate distributing forces through the cutting tip and the toolholder, particularly where at least three through holes are provided.

The cutting tip 23 typically comprises an axial stop 61. In the embodiment shown in FIGS. 1A-1B, the axial stop 61 comprises a radially extending surface 63 that forms at least part of the axial stop and abuts against a top end 73 of the toolholder 37 to prevent further axial movement of the shank portion 27 of the cutting tip 23 into to the toolholder. In this embodiment, the radially extending surface 63 forms a bottom of the tool portion 25 and forms a 90° angle with an axis of the shank portion.

The cutting tip 23 also comprises a centering member in the form of a frustoconical portion 65 having a circumferentially largest end 67 closer to a first end 69 of the shank portion 27 closest to the tool portion 25 than to an opposite, second end 71 of the shank portion. The frustoconical portion 65 can facilitate radially positioning the shank portion 27 of the cutting tip 23 in the axial opening 41 of the toolholder 37, i.e., centering the shank portion, by being caused to abut a corresponding frustoconical portion 65′ in the axial opening 41 of the toolholder 37. The axial stop 61 is a separate structure from the frustoconical portion 65, thereby facilitating ensuring precise axial positioning of the cutting tip 23 and facilitating avoiding under- or overtightening of the cutting tip relative to the shank portion 27.

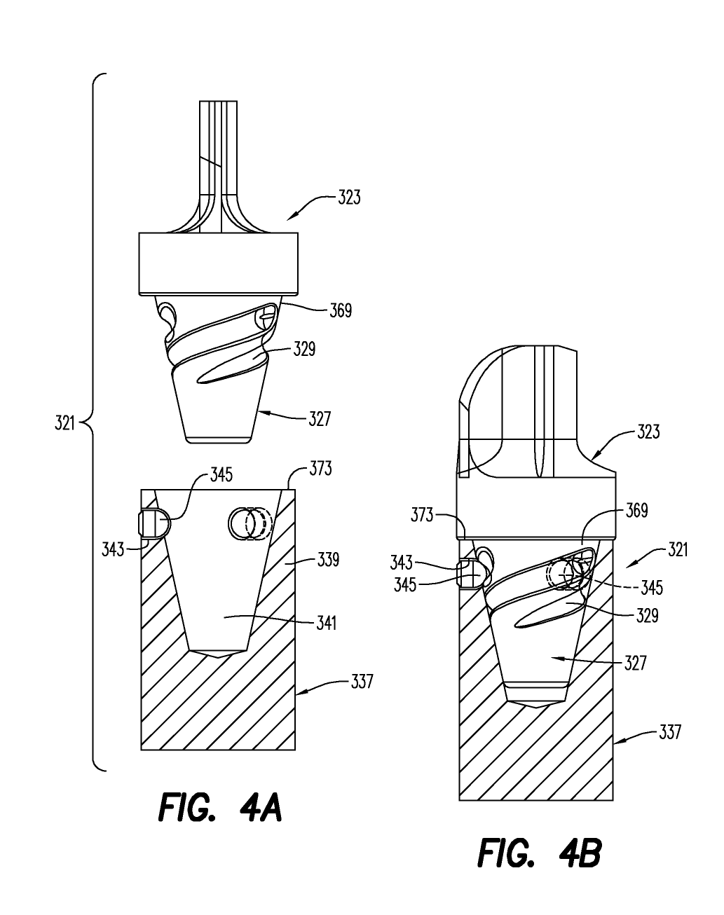

In the embodiment shown in FIGS. 1A-1B, the groove 29 comprises a substantially entirely circumferentially extending portion in the sense that the groove is helical and extends around a substantial portion of the circumference of the shank portion 27. Ordinarily, the groove 29 extends around less than 360° of the circumference of the shank portion 27 to facilitate formation of the groove and to minimize an amount of turning that must be performed to secure the cutting tip 23 relative to the toolholder 37, however, as shown in phantom in FIG. 1A, the groove can extend 360° around the circumference of the shank portion. Were the groove 29 to extend, for example 360° around the circumference of the shank 27 in the embodiment of FIGS. 1A and 1B, the position of the through holes 43 could be located closer to a top end 73 of the toolholder 37. In addition, the top end of each groove 29 could be closer to the first end 69 of the shank 27. As seen in FIGS. 5A-5D, the top end of each groove 429 can closer to the first end of the shank portion than to an opposite, second end of the shank portion.

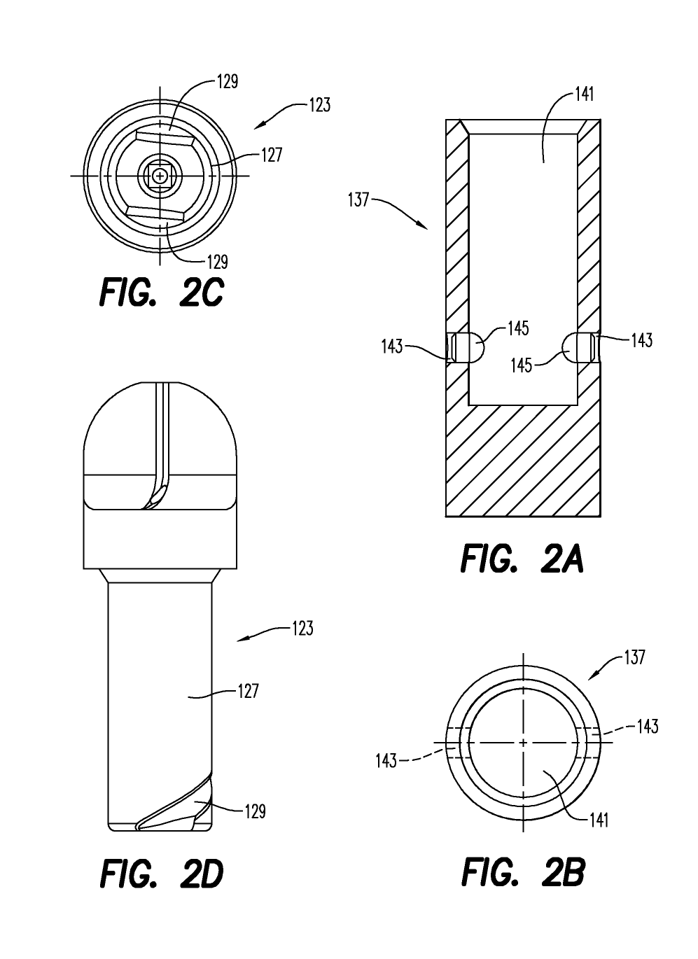

FIGS. 3A-3B show a cutting tool 221 that is similar in many respects to the cutting tool 21 shown in FIGS. 1A-1D. The cutting tip 223 comprises a groove 229 comprising an axially extending portion 275 and the circumferentially extending portion 231. As seen in FIG. 3A, the circumferentially extending portion 231 meets the axially extending portion 275 at a first end 231a of the circumferentially extending portion and ordinarily comprises a pitch so that a second end 231b of the circumferentially extending portion is disposed closer to the first end 269 of the shank portion 227 than to an opposite, second end 271 of the shank portion, i.e., the circumferentially extending portion 231 is ordinarily a helical portion. Providing a groove 229 with an axially extending portion 275 and a circumferentially extending portion 231 can facilitate attachment of the cutting tip 223 to the toolholder 237 with a minimal amount of turning of the cutting tip relative to the toolholder while locating the points at which the at least partially spherical members 245 are received in the grooves 229 at a distance from the second end 271 of the shank portion 227.

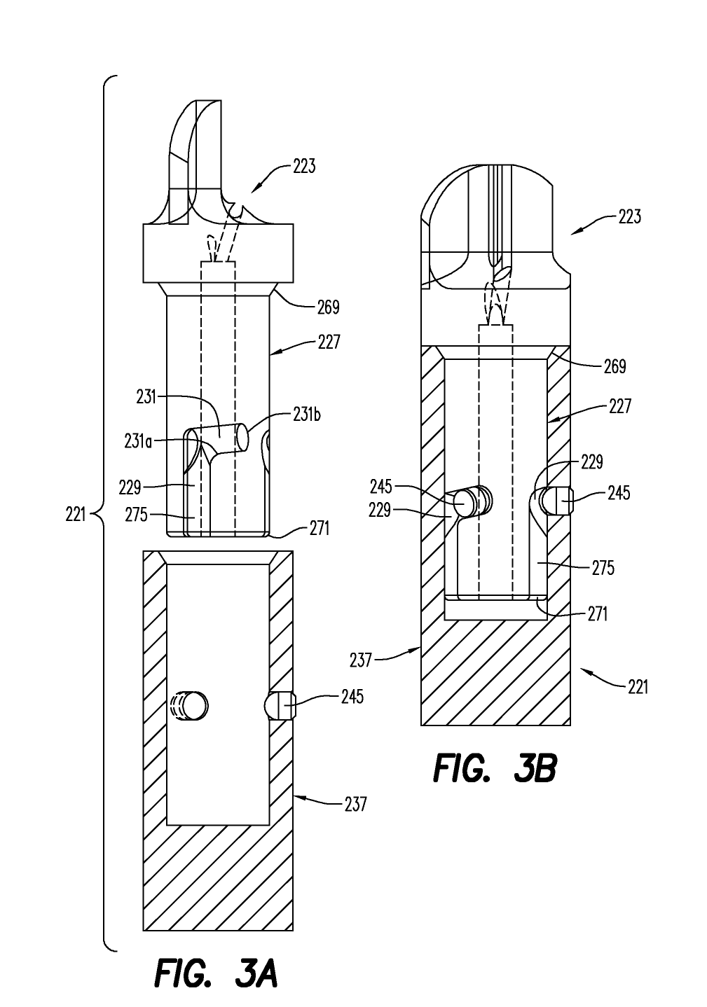

FIGS. 4A-4B show a cutting tool 321 that is similar in many respects to the cutting tool 21 shown in FIGS. 1A-1D. The shank 327 of the cutting tip 323 is frustoconical and, as a consequence, the grooves 329 in the shank do not extend to the bottom of the shank to mate with at least partially spherical members 345 extending through through holes 343 in the wall 339 of the toolholder 337. The axial opening 341 of the toolholder 337 is ordinarily also frustoconical when used in connection with a cutting tip 323 having a frustoconical shank 327. The frustoconical shape of the shank 327 and the axial opening 341 can facilitate attachment of the cutting tip 323 to the toolholder 337 quickly and with relatively few turns, and with the grooves 329 and at least partially spherical members 345 mating relatively close to the first end 369 of the shank 327 of the cutting tip and/or relatively close to the top end 373 of the toolholder. The frustoconical shape of the shank 327 also facilitates centering of the cutting tip 323 relative to the toolholder 337 in a fashion similar to the frustoconical portion 65 on the cutting tip 23 shown in FIGS. 1A-1D. The frustoconical shank 327 will ordinarily also be a separate structure from an axial stop, usually in the form of a radially extending surface forming a bottom part of the tool portion of the cutting tip.

FIGS. 5A-5D show components of yet another cutting tool with a cutting tip 423 (FIGS. 5A-5B) having a frustoconical shank 427. The groove 429 comprises a circumferentially extending portion 431 and an axially extending portion 475. In this way, the attachment of the cutting tip 423 to the toolholder 437 (FIGS. 5C-5D) can be accomplished even more quickly and with even fewer turns than with the embodiment shown in FIGS. 4A-4B, and with the grooves 429 and at least partially spherical members 445 mating relatively close to the first end 469 of the shank.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

The disclosures in Swedish patent application No. 0950194-1, from which this application claims priority, are incorporated herein by reference.

1. A cutting tip for a cutting tool, comprising:
a tool portion comprising a cutting edge; and
a shank portion connected at a first end to the tool portion wherein the tip comprises at least three grooves, at least a portion of each groove extending circumferentially around at least part of the shank portion, a centering structure for centering the shank portion relative to an opening in a toolholder, and an axial stop for limiting axial movement of the shank portion into the opening in the toolholder, the axial stop and the centering structure being different structures.

2. The cutting tip as set forth in claim 1, wherein each groove comprises at least one of a radiused surface, a substantially rectangular surface, and a substantially V-shaped surface.

3. The cutting tip as set forth in claim 1, comprising a radially extending surface forming at least part of the axial stop.

4. The cutting tip as set forth in claim 3, wherein the radially extending surface forms a bottom of the tool portion.

5. The cutting tip as set forth in claim 3, wherein the radially extending surface forms a 90° angle with an axis of the shank portion.

6. The cutting tip as set forth in claim 1, wherein the centering structure comprises a frustoconical portion having a circumferentially largest end closer to the first end of the shank portion than to an opposite, second end of the shank portion.

7. The cutting tip as set forth in claim 1, wherein the shank portion is frustoconical, has a circumferentially largest end closer to the first end of the shank portion than to an opposite, second end of the shank portion, and forms the centering structure.

8. The cutting tip as set forth in claim 1, wherein each groove comprises an axially extending portion and the circumferentially extending portion.

9. The cutting tip as set forth in claim 8, wherein the circumferentially extending portion meets the axially extending portion at a first end of the circumferentially extending portion and comprises a pitch so that a second end of the circumferentially extending portion is disposed closer to the first end of the shank portion than to an opposite, second end of the shank portion.

10. The cutting tip as set forth in claim 1, wherein each groove extends at least 360° around the shank.

11. The cutting tip as set forth in claim 1, wherein each groove extends less than 360° around the shank.

12. The cutting tip as set forth in claim 1, wherein a top end of each groove is closer to the first end of the shank portion than to an opposite, second end of the shank portion.

13. A cutting tool comprising a cutting tip as set forth in claim 1 and a toolholder comprising a wall (39) defining an axial opening for receiving the shank portion of the cutting tip, the wall comprising at least three through-holes, and at least three at least partially spherical members, each at least partially spherical member being received in a corresponding through hole such that a spherical portion of the at least partially spherical member extends through the through hole into the axial opening, wherein the cutting tip is secured to the toolholder when the shank portion of the cutting tip is received in the axial opening and at least part of the spherical portion of each of the at least partially spherical members is received in a corresponding one of the grooves in the cutting tip.

14. The cutting tool as set forth in claim 13, wherein each at least partially spherical member comprises a shoulder and each through-hole comprises a shoulder, each shoulder of each at least partially spherical member and the shoulder of the corresponding one of the through-holes being arranged so that an extent to which the spherical member is adapted to extend into the axial opening is limited.

15. The cutting tool as set forth in claim 14, wherein the cylindrical portion of each at least partially spherical member comprises an external thread, and each through-hole comprises an internal thread for mating with the external thread on the at least partially spherical member.
